(19) United States
(12) Patent Application Publication
(10) Pub. No.: US 2002/0146140 A1
(43) Pub. Date: Oct. 10, 2002

(54) SPEAKER ASSEMBLY

(76) Inventor: SHUN-PUI CHIU, KOWLOON (HK)

Correspondence Address: JACOBSON PRICE HOLMAN & STERN, 400 SEVENTH STREET NW, WASHINGTON, DC, 20004

(21) Appl. No.: 09/172,296

(22) Filed: Oct. 14, 1998

(51) Int. Cl. H04R 1/02; H04R 9/06

(52) U.S. Cl. 381/332; 381/334; 381/336; 381/386; 181/199

(57) ABSTRACT

This invention provides a speaker assembly for particular use in conjunction with lap-top computers or similar. Adjacent housing portions are provided to contain speakers and are interconnected so that the housings may be movable between a co-planar position and a non co-planar position. The non co-planar position allows the speakers in adjacent housings to have some focusing of the sound propagating from the speakers to provide enhanced performance despite the relatively small thin nature of the speakers provided in each housing. When in the non co-planar configuration, the front faces of the housings provide a concave overall appearance to the speaker assembly towards the user and help support each other against overturning.

### BACKGROUND TO THE INVENTION

1. Field of the Invention

This invention relates to a speaker assembly and a method of manufacturing a speaker assembly. In particular, although not necessarily solely, the invention relates to speaker assemblies for use in conjunction with portable equipment such as lap-top computers.

2. Description of the Prior Art

Recent times have seen considerable advances in the miniaturization of components. This has led to a gradual decrease in the size of hardware and an increase in functionality. The general trend of miniaturization has led to the introduction of lap-top computers being highly portable computers with still a comprehensive range of functions available on the computer.

Although the lap-top computer now has sufficient functionality for good performance over the Internet when used in conjunction with a modem and sufficient power in functionality for the operating of complex computer software, such portable computers have had difficulty in providing any reasonable audio performance when compared with less portable workstations.

Current lap-top computers generally use in-built speakers within the cabinet of the computer. The speakers themselves do not have particularly high output nor high performance. Although a range of better speakers are available in the form of speakers capable of being plugged into ports on the computer, the speakers themselves are not particularly portable. Generally the speakers will be left at a workstation either at an office or at home and the in-built speaker used when not at that location. Such speakers as can be purchased readily in the market are not easily transported in the same carry case utilized for the transportation of lap-top computers. They are generally too bulky for such carry cases or too heavy for easy portability.

Relatively thin small speakers themselves are available as components. Although such speakers are known, individual speakers have generally insufficient performance to be an attractive alternative.

### OBJECT OF THE INVENTION

It is an object of the present invention to provide a speaker assembly and a method of manufacturing a speaker assembly having a relatively thin overall housing with some improved performance to overcome disadvantages of the prior art or at least provide the public with the useful choice.

### SUMMARY OF THE INVENTION

Accordingly, in a first aspect, the invention consists in a speaker assembly comprising:

a first housing portion;

at least a second housing portion adjacent and connected to said first housing portion;

at least one speaker in each housing portion; and

said housing portions being interconnected to accommodate configuration in a first or co-planar configuration and a second or non co-planar configuration.

Accordingly, in a second aspect, the invention consists in a speaker assembly comprising:

providing a first housing portion containing at least one speaker;

providing a second housing portion containing at least one further speaker; and

interconnecting said housing portions along an adjacent edge with a connection means to allow said adjacent housing portions to be arranged in a co-planar configuration and a non co-planar configuration.

### BRIEF DESCRIPTION OF THE DRAWINGS

Preferred embodiments of the invention will now be described with reference to the drawings in which:

FIG. 1 is a perspective view of one embodiment of the invention in a first configuration;

FIG. 2 is a perspective view of the apparatus of FIG. 1 in a second configuration;

FIG. 3 is a perspective view of a second embodiment in a first configuration;

FIG. 4 is a plan view of the second embodiment in a second configuration;

FIG. 5 is a front elevation view of the second embodiment in the first configuration;

FIG. 6 is a schematic cross section through the apparatus of FIG. 5;

FIG. 7 is a schematic circuit diagram for an apparatus in accordance with the first or second embodiments;

FIG. 8 is a plan view of the second embodiment in a workstation environment;

FIG. 9 is a further perspective view of said second embodiment;

FIG. 10 is a perspective view of a third embodiment in a first configuration;

FIG. 11 is a perspective view of the third embodiment in a second configuration;

FIG. 12 is a plan view of the third embodiment in the first configuration;

FIG. 13 is a front elevational view of the third embodiment in the second configuration; and

FIG. 14 is a schematic cross sectional view through the apparatus of FIG. 13.

### DETAILED DESCRIPTION OF PREFERRED EMBODIMENTS

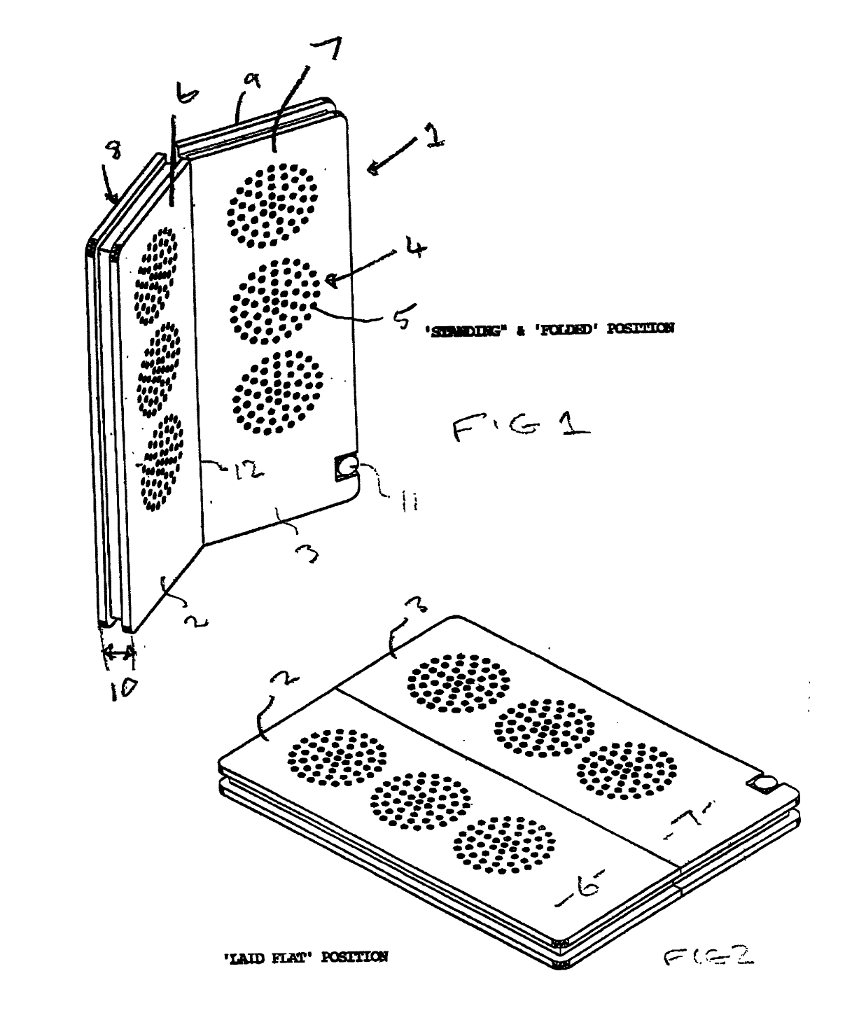

Preferred embodiments of the invention will now be described with reference to the drawings. A first embodiment of the invention is shown in FIG. 1 being a speaker assembly 1 having a first housing portion 2 and a second housing portion 3. Each housing portion 2 and 3 contains at least one or preferably more speakers 4. As shown in FIG. 1, the speakers are contained within the housing portions 2 and 3 and it is the apertures 5 for release of the speaker output from the housing which are visible in this view. However, it can be envisaged that there are individual speakers behind each of the arrays of apertures provided in the front face of 6 and 7 of the housing portions 2 and 3.

It can be seen that each of the housing portions 2 and 3 are provided with front faces 6 and 7 respectively and co-operating rear faces 8 and 9. The housings 2 and 3 are relatively thin with the separation between the front and rear face portions being relatively small. The side wall distance 10 between the front and rear faces of each housing portion may be provided as less than 2 cm, or, preferably, approximately 1 cm.

To achieve this, relatively low profile speaker portions 4 are contained within the housings 2 and 3.

Control means 11 in the form of, for example, a volume control may be provided at a convenient location on at least one of the housings.

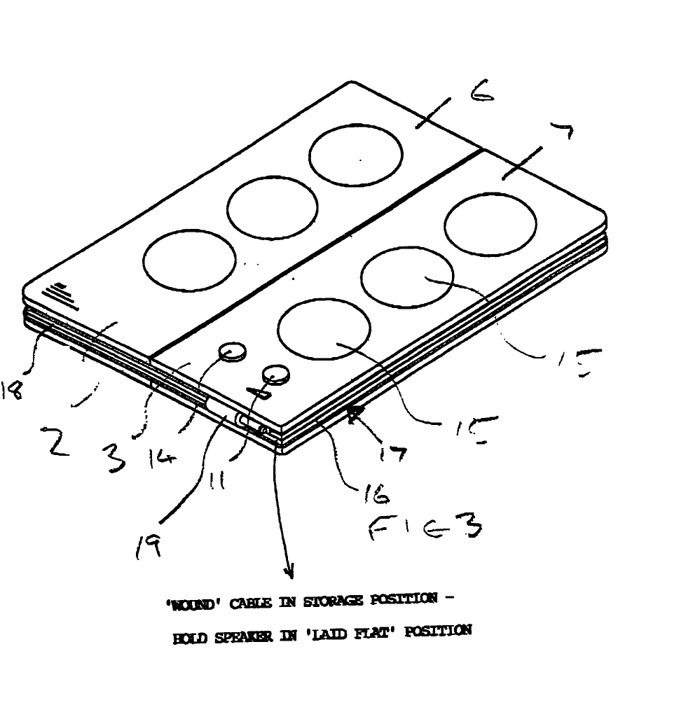

As shown by comparison of FIG. 1 and FIG. 2, the speaker assembly 1 is capable of at least two configurations. These configurations comprise a planar configuration as shown in FIG. 2 in which the housing portions 2 and 3 are adjacent one another and their front faces 6 and 7 lie substantially on a common plan. In the alternative configuration shown in FIG. 1, the front faces 6 and 7 and, the housings 2 and 3 themselves are no longer in the same plane. Instead, an angle is opened at the region of connection 12 between the housing portions 2 and 3. The housing portions 2 and 3 may be hingedly or flexibly connected to accommodate this non-planar configuration.

Referring to FIG. 3, a second embodiment is shown very similar to the first embodiment. In this embodiment, the control means 11 comprises both a volume control as with the control means 11 in the previous embodiment and an additional control means 14 for tone control. Again, the position of low profile speakers is shown in regions 15 on the front faces 6 and 7 of the first and second housing portions 2 and 3.

As can also be seen in this embodiment, a recess 16 is provided around the perimeter of the complete housing. This recess in the side wall 17 of the combined housing allows a cable 18 and plug 19 to be accommodated and recessed within the outer limits of the housing. The cable 18 and plug 19 may be suitable for attachment of the speaker assembly to a suitable apparatus such as a lap-top computer or other apparatus.

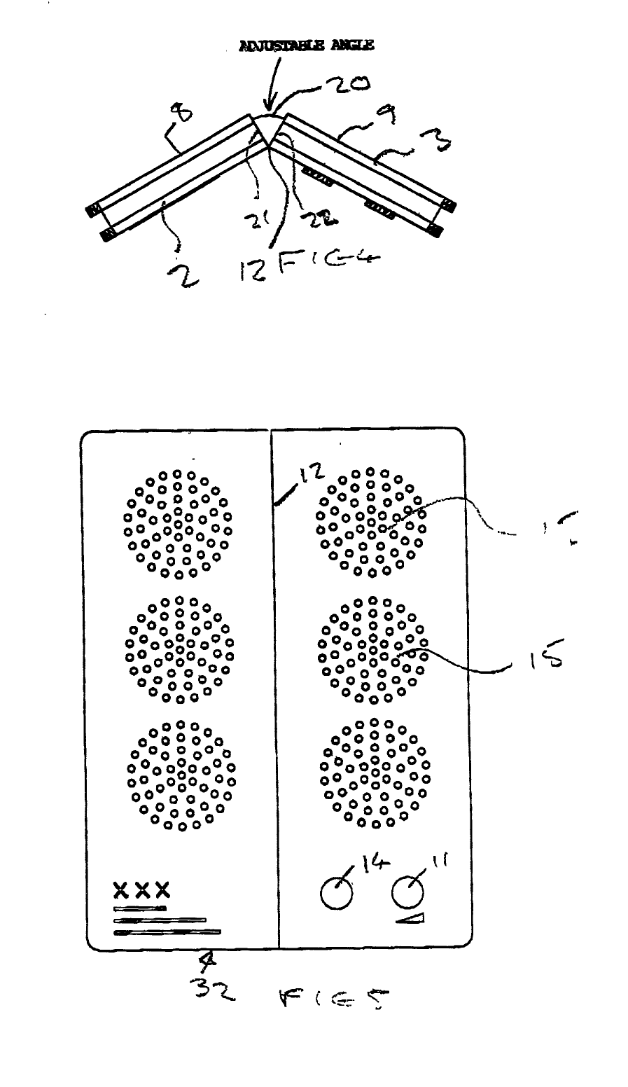

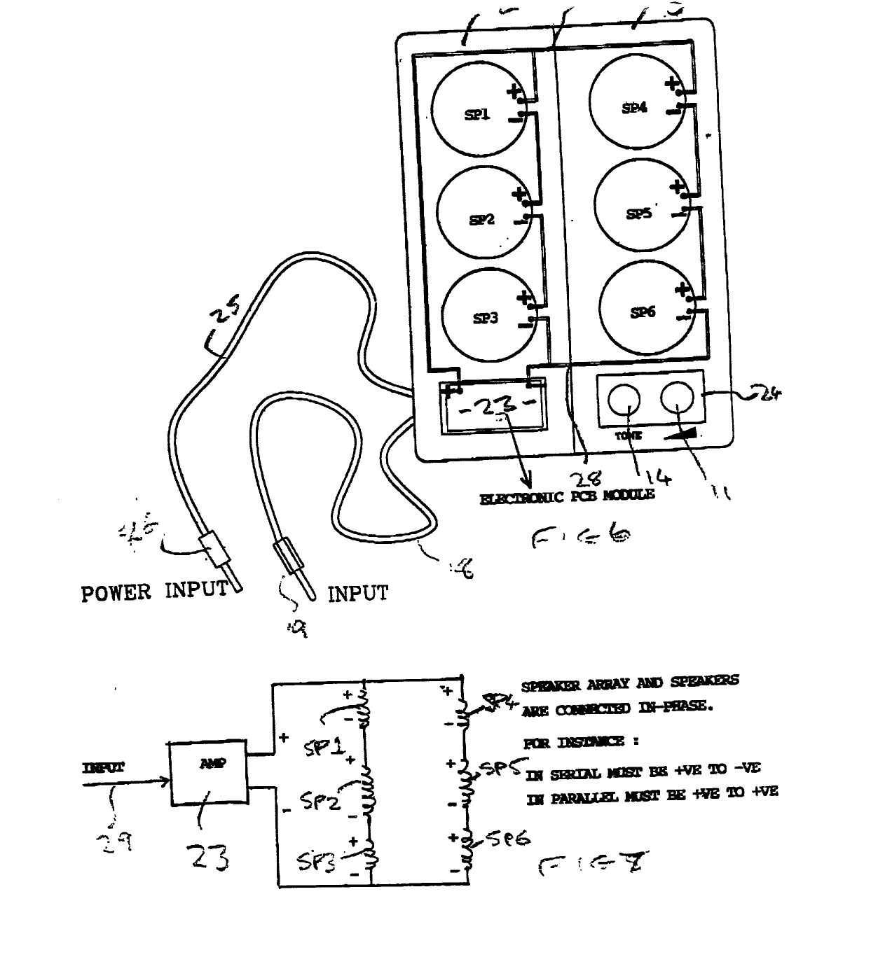

Referring to FIG. 4, the second embodiment apparatus can be seen in a further configuration similar to the configuration of the first embodiment in FIG. 1. It can be seen that the housing portions 2 and 3 are no longer co-planar but are still interconnected by a connection portion 20. This connecting portion retains the housing portions 2 and 3 together while allowing them to move from the co-planar position to the non co-planar position. This interconnection 20 can either be a flexible connection or merely some form of hinge. In the preferred form, the interconnection 20 may include a solid housing portion to protect wires or other connections between the housing portions 2 and 3. This interconnecting portion 20 may be accommodated within the adjacent ends 21 and 22 of the housings when in the planar configuration as shown in FIG. 5. When in the non co=planar position as shown in FIG. 4, the hinge portion is exposed at the rear of the speaker and still protects any wires or similar running between the housings. The housing portions 2 and 3 may be adjustable to any angle from the planar position to, if desired, a maximum angle. This maximum angle may be set by limits (not shown) provided on the interconnecting portion 20 or by limits on any hinge or similar. This may inhibit further separation of the rear faces 8 and 9 of the housings 2 and 3 while the front faces 6 and 7 are still retained in contact along the line of connection 12.

Rather than a separate interconnecting portion 20, it may be possible to provide an alternative embodiment with merely a flexible portion intermediate of the housing portions 2 and 3. The flexible portion may still provide some support for each of the housing portions 2 and 3 from the other while allowing adjustment of the angle between them.

Referring to FIG. 6, a schematic diagram of the second embodiment is provided. It can be seen that the housings 2 and 3 may each accommodate a plurality of speakers being, in this particular preferred embodiment, three speakers in each housing portion. Beneath the speakers, there may be provided associated apparatus such as an amplifier or electronic PCB module 23. It can also be seen that the control means for volume and tone being variable control knobs can be connected to an associated controller 24 to supply information to the amplifier or electronic module controlling the speaker performance.

In this embodiment, a cable 18 for the plug 19 is provided to receive the desired sound signal from an output from a computer lap-top or other apparatus. In addition, a further connection means being a cable 25 and plug 26 is provided. This may be utilized for providing a power input to the speaker assembly. This may reduce the size of the speaker assembly if the assembly is to be powered from an external source. Again, this external power source may be provided from an associated apparatus such as a computer or other apparatus with which the speaker assembly may be used.

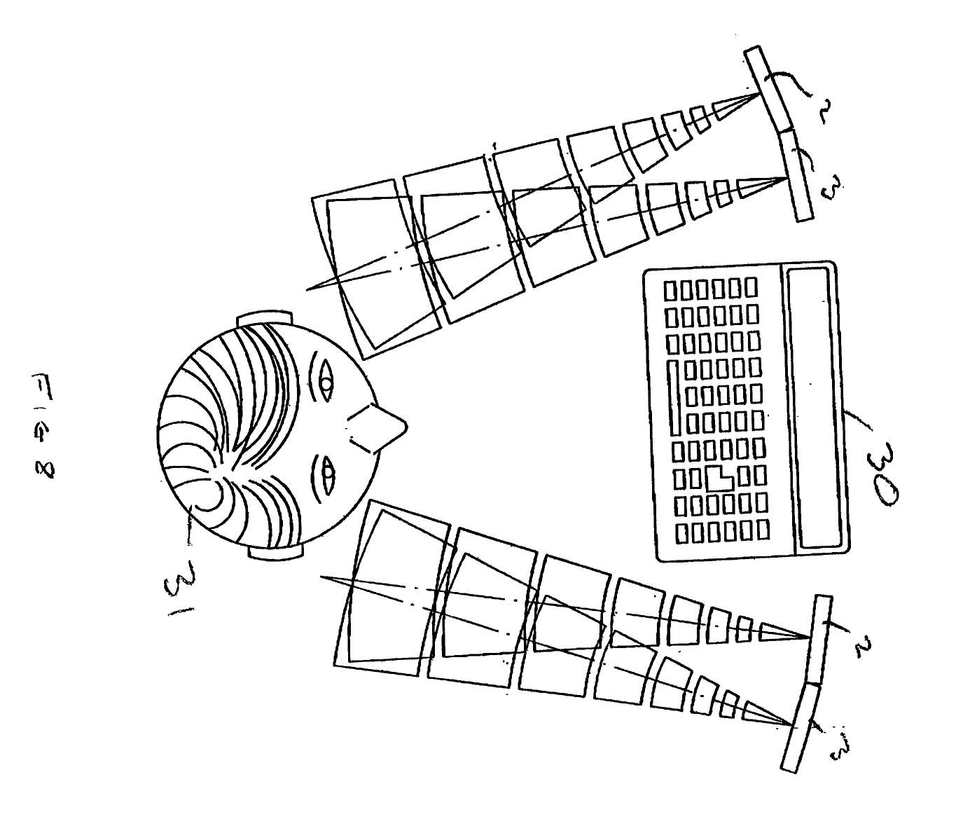

As shown in FIG. 6 and further demonstrated in FIG. 7, it is desirable to connect the speaker array such that the speakers are in phase with each other. Individual speakers in each portion of the housing may be connected in series such as speakers SP1, SP2 and SP3 in the first housing portion 2 and speakers SP4, SP5 and SP6 in the second housing portion 3. Each array of speakers in each housing may be connected in parallel with the array in the adjacent housing. Referring to FIG. 6, it can be seen that the wires 27 and 28 for the parallel connection together with any interconnection between the control box 24 and the associated electronic module 23 needs to pass between the housings 2 and 3 and it is to protect this that it may be preferred to provide a more rigid connection means 20. Alternatively, a hinge may be provided and separate protective portion provided to carry the wires.

Referring to FIG. 7, it can be seen that the input 29 may be provided to an amplifier or similar 23 and then progress to the speaker arrays in each of the housings.

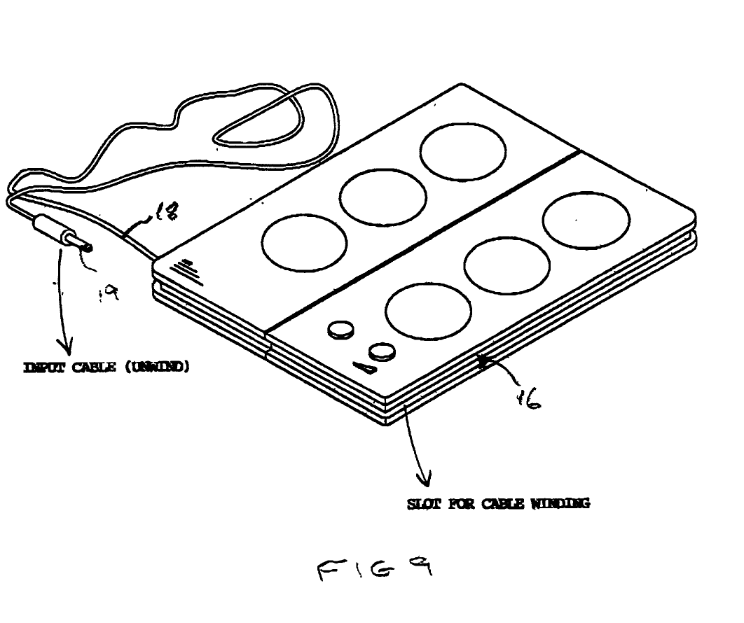

FIG. 8 shows two such speaker assemblies provided in a workstation environment. In this figure, the advantages of the speaker assembly can be seen. A user 31 having an associated hardware such as a lap-top computer 30 or similar can arrange, preferably, two such speaker assemblies such that one of such assemblies is on either side of the workstation 30. By placing the housing portions 2 and 3 in a non-planar configuration, the speaker arrays in each housing portion may be focused to overlap as the sound propagates towards the user. This can provide enhanced performance despite the relatively small nature of the individual speaker components used within the assemblies.

Furthermore, such an arrangement while still maintaining interconnection between the housing portions 2 and 3 allow the housing portions to support each other. Due to the relatively thin nature of the speaker assemblies, the base 32 as shown in FIG. 5 may also be rather thin and provide some difficulty in stabilizing the speaker assemblies in the upright position. The non co-planar configuration provides increased stability towards the front and rear of the speaker assemblies to resist overturning of the speaker assemblies from the upright position.

FIG. 9 is a further view of the embodiment shown in FIG. 3 although in this instance, the cable 18 and plug 19 are shown unwound from the slot 16. It can be seen that a reasonable length of cable 18 may be accommodated around the perimeter of the housing.

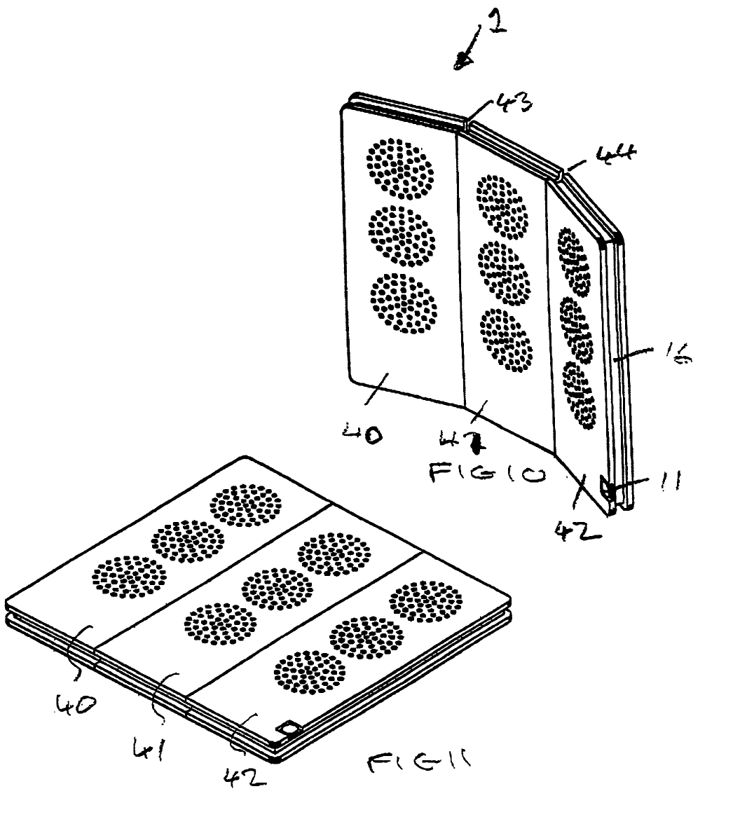

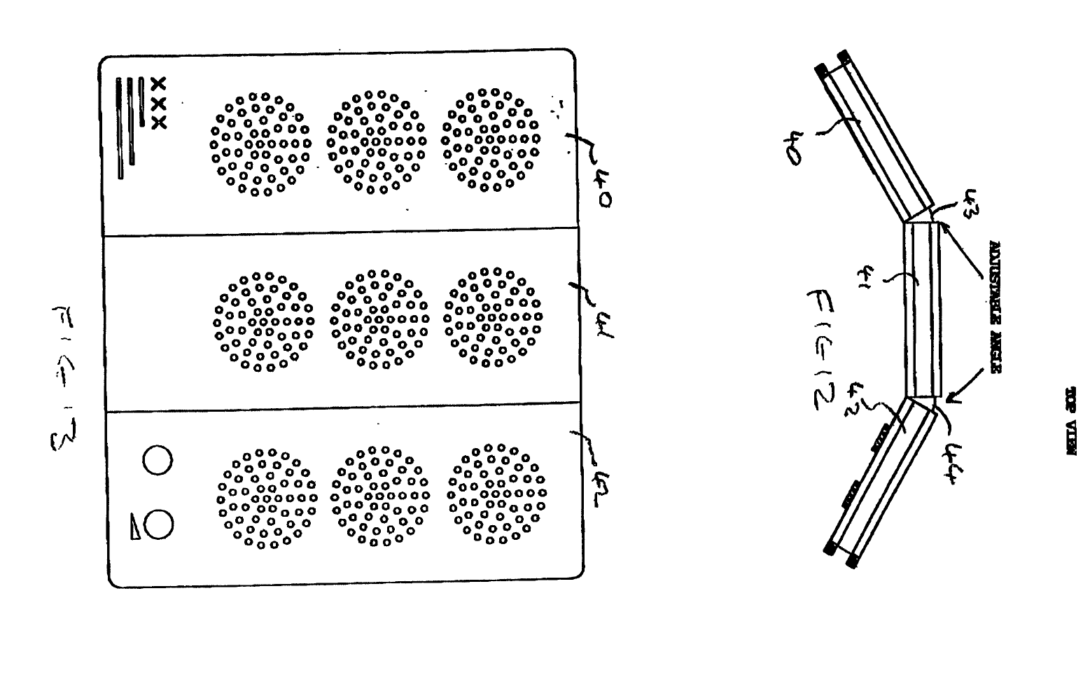

FIGS. 10 through 14 show a yet further preferred embodiment of the invention. In this embodiment, the speaker assembly 1 is provided with three housing portions being portions 40, 41 and 42. It is preferred that each of the adjacent edges of the housing portions received an interconnection 43 and 44 which allows some rotation. Again, this may be a rigid hinge portion, flexible portion or other connection which allows the front faces to provide a generally concave presentation towards the front being the direction in which the speakers are presented for propagation. Otherwise the speaker assembly 1 is provided in generally the same form as previously with, again, a slot 16 progressing around the perimeter edges of the entire assembly. Also a suitable control means such as a control means 11 or more controls may be provided if desired. This alternative design is shown in the non co-planar configuration in FIG. 10 and in the lie flat configuration in FIG. 11.

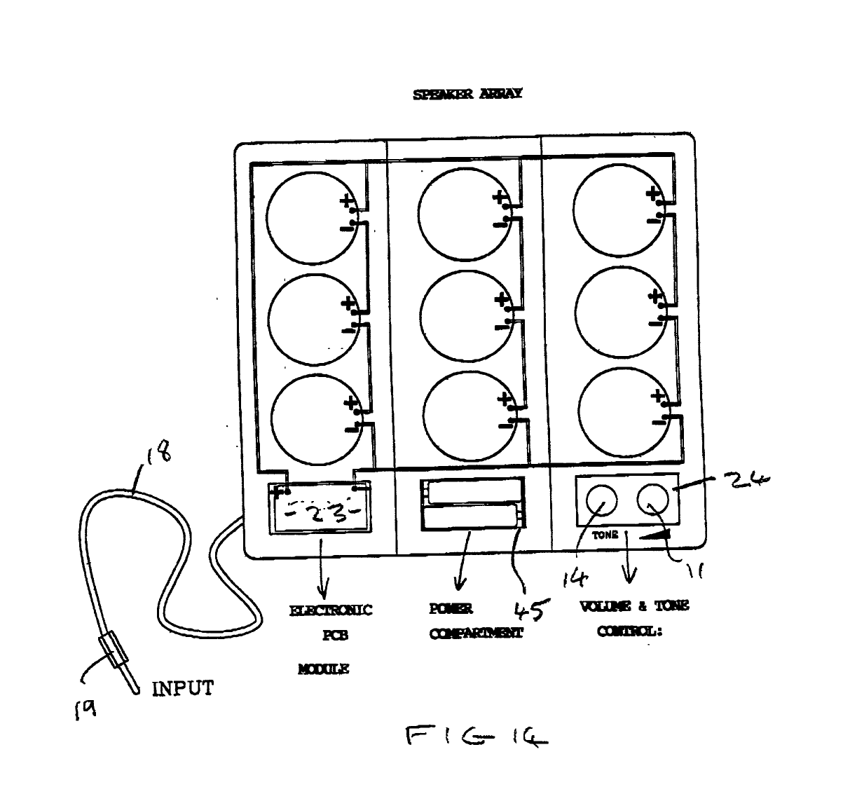

FIG. 12 provides a plan view of the apparatus in the configuration as shown in FIG. 10 and FIG. 13 provides the front elevation of the co-planar configuration.

Referring to FIG. 14, the speaker array is shown to also comprised three speakers in each of the housing portions. Although there should be at least one speaker in each housing unit, there is no necessity that the number provided have any particular limit other than the limit that the overall size of the unit will allow. Furthermore, it is not necessary, although it is preferred, that the number of speakers in each housing unit be the same.

FIG. 14 shows an input 18 with plug 19 as per previous embodiments. An electronic PCB module acting as an amplifier and to interpret signals from the control box 24 can be provided as unit 23, again in accordance with previous embodiments. However, having three housing portions in this example, extra room may be available in the additional housing unit to carry a power compartment 45. This power compartment may incorporate one, two or more batteries of suitable size for the overall apparatus. This will provide the speaker array with its own power source reducing the need for connection with an external power source.

In manufacturing the assembly, the housing units may be manufactured from suitable materials for speaker housings. This may include a relatively rigid plastic material. Of course, alternative materials may be utilized as required. The speakers may be provided as small thin profile speakers available commercially. The wiring or cabling can also be of any suitable material that is capable of conductively connecting the components.

To manufacture these preferred embodiments, the front and rear faces, for example 6 and 8 of housing unit 2, may be molded as separate pieces with the side wall incorporated on one of the pieces. Once the components are fitted within the housing, this may be simply clipped, screwed, glued or otherwise fitted together to provide the overall assembly. The connecting portions such as portions 20 can be fitted into two such adjacent housings before the front and rear faces are placed together to trap ends of the connecting portion 20 within each housing. Of course, such a step depends on the type of connecting portion 20 provided.

The complete speaker assembly 1 is intended to have an overall planar surface area of the front surfaces 6 and 7 of approximately half the area of a lap-top computer. In this manner, two such units as shown in FIGS. 1 and 2 may be placed adjacent to each other and with the front faces 6 and 7 against the top or base of a lap-top computer when packaged together. It can be seen that the speaker assembly only provides a minimal increase in overall depth to the lap-top computer when being packaged into a carry case or similar. If an array as shown in FIG. 14 is provided, this may be provided as a single speaker array for use in conjunction with the lap-top computer and sized to the entire surface area or footprint of the lap-top computer. Alternatively, two such assemblies may be provided either to lie adjacent to each other or on top of each other. The overall size constraint of the speaker assembly will be determined accordingly.

Of course, not all lap-top computers have identical footprints and the size may be varied accordingly. In such a manner, the speakers may be provided as proprietary attachments to particular lap-top computers.

The preferred embodiments have referred to use of such speaker assemblies in conjunction with lap-top computers. Other portable apparatus may equally benefit from a standalone relatively thin speaker assembly. This can incorporate any form of portable hardware producing a sound signal capable of being interpreted and propagated by such speakers.

Thus it can be seen that the invention provides speaker assemblies which are relatively portable with comparison to other speaker assemblies. By being able to be nested against the lap-top computer, they can be easily incorporated within the same carry case. Furthermore, the performance can be enhanced through some focusing of the sound propagating from the speakers through the ability of the adjacent speaker assemblies to be arranged at an angle to each other. The small or narrow base of the speaker assemblies will still allow the speakers to be freestanding once placed at an angle to each other and partially supporting each other.

Further embodiments of the invention will be envisaged by those skilled in the art with the invention itself not being defined by these embodiments which are provided by way of examples only. Any integers recited in the embodiments are to incorporate known equivalents as may be suitable.

1. A speaker assembly comprising:
a first housing portion;
at least a second housing portion adjacent and connected to said first housing portion;
at least one speaker in each housing portion; and
said housing portions being interconnected to accommodate configuration in a first or co-planar configuration and a second or non co-planar configuration.

2. A speaker assembly as claimed in claim 1 wherein said housing portions are interconnected along an adjacent edge and present a concave front face to the assembly wherein said non co-planar configuration.

3. A speaker assembly as claimed in claim 1 wherein each housing portion contains a plurality of speakers in series with each other.

4. A speaker assembly as claimed in claim 1 wherein speakers in adjacent housings are in parallel with each other.

5. A speaker assembly as claimed in claim 1 wherein each housing portion has a dimension between front and rear faces of said housing portion of not greater than 2 cm.

6. A speaker assembly as claimed in claim 5 wherein said dimension between said front and rear faces of each housing portion is approximately 1 cm.

7. A speaker assembly as claimed in claim 1 wherein said housings support each other to be freestanding on a lower peripheral edge when in said non co-planar configuration.

8. A speaker assembly as claimed in claim 1 wherein a groove or recess is provided about peripheral edges of said assembly to accommodate a cable or wire for interconnection with a signal source.

9. A speaker assembly as claimed in claim 8 wherein said signal source is a computer outlet.

10. A speaker assembly as claimed in claim 1 wherein said assembly is sized and configured such that a front face of said assembly is no larger than the footprint of a typical lap-top computer.

11. A speaker assembly as claimed in claim 1 wherein at least one of said housing portions contains an electronic module to provide amplification to an input signal.

12. A speaker assembly as claimed in claim 1 wherein at least one of said housing portions contains control means for control of volume and/or tone from speakers within said housing.

13. A speaker assembly as claimed in claim 1 wherein at least one housing portion contains a power source.

14. A method of manufacturing the speaker assembly comprising:
providing a first housing portion containing at least one speaker;
providing a second housing portion containing at least one further speaker; and
interconnecting said housing portions along an adjacent edge with a connection means to allow said adjacent housing portions to be arranged in a co-planar configuration and a non co-planar configuration.
